(19) United States
(12) Patent Application Publication
(10) Pub. No.: US 2009/0123032 A1
(43) Pub. Date: May 14, 2009

(54) MEASUREMENT OF GAPS BETWEEN VALVE SEATS AND ATTACHMENT PARTS

(75) Inventors: Mitsuhiro Kanisawa, Tokyo (JP); Mitsuo Tsuborai, Tokyo (JP)

Correspondence Address: STANDLEY LAW GROUP LLP, 6300 Riverside Drive, Dublin, OH, 43017, US

(73) Assignee: HONDA MOTOR CO., LTD., Tokyo (JP)

(21) Appl. No.: 12/090,711

(22) PCT Filed: Mar. 12, 2007
(86) PCT No.: PCT/JP2007/055332

§ 371 Date: Apr. 18, 2008

(30) Foreign Application Priority Data
Mar. 24, 2006 (JP) 2006-082832

(51) Int. Cl. G06K 9/00

(52) U.S. Cl. 382/106

(57) ABSTRACT

An apparatus for measuring gaps that form between attachment parts (15) in exhaust ports. of an engine, and valve seats (16) provided to the attachment parts. This apparatus comprises, at one end of a cylinder (21), white light-emitting diodes (25) for emitting light orthogonal to a longitudinal axis (24) of the cylinder. An optical axis (26) from the light-emitting diodes is bent by 90° by a mirror (27). Color images obtained by a CCD camera (28) provided at the other end of the cylinder are binarized by a color image processor (29) with a range of hue, a range of chroma, and a range of brightness.

### TECHNICAL FIELD

The present invention relates to a gap measurement apparatus for measuring gaps formed between valve seats and attachment parts after the attachment parts are formed in exhaust ports of an engine and the valve seats are press-fitted into these attachment parts. The invention also relates to a method for determining these gaps.

### BACKGROUND ART

A cylinder head of an engine is provided with exhaust ports. These exhaust ports are opened and closed with air intake valves and air release valves. The members with which the air intake valves and air release valves are in direct contact are referred to as valve seats, and these valve seats must be durable. For example, structures are used in which steel valve seats are press-fitted into cylinder heads made from aluminum alloy castings.

Specifically, seat-accommodating attachment parts (hereinafter referred to as “attachment parts”) are formed by cutting in the cylinder heads, and valve seats are press-fitted into the attachment parts. If the press-fitting is inadequate, gaps form between the valve seats and the attachment parts. It is preferable that these gaps do not form, but they are allowable to an extent (10 μm, for example) because of nonuniformities in machining.

After press-fitting is complete, it is important to measure the gaps that have formed between the valve seats and the attachment parts, and to confirm that the gaps are within an allowable limit.

It is preferable that the gaps be automatically confirmed because an automatic confirmation procedure requires less time. In view of this, in the past, gaps have been inspected with an inspection apparatus that uses a camera and a triangular prism mirror such as is disclosed in Japanese Patent Laid-Open Publication No. 7-286824 (JP 7-286824 A), for example.

The technique in JP 7-286824 A will now be described with reference to the FIG. 9A hereof.

As shown in FIG. 9A, an inspection apparatus 100 is composed of a triangular prism mirror 101; an imaging device 102 for capturing images of a long, thin inspected part; a binarization device 103 for binarizing the gray images captured by the imaging device 102; a substitution device 104 for substituting the binarized images with equivalent ellipsoids; and a calculation device 105 for calculating the minor axis lengths of the obtained equivalent ellipsoids.

After a valve seat 109 is press-fitted into an attachment part 108 provided to a cylinder head 107, a triangular prism mirror 101 is made to face a gap 111 between the attachment part 108 and the valve seat 109, and an image is taken and binarized.

The horizontally long figure D shown in FIG. 9B is obtained. Furthermore, an equivalent ellipsoid of the horizontally long figure D is calculated, resulting in the equivalent ellipsoid E, and the length of the minor axis of this equivalent ellipsoid E is a value equivalent to the gap. This minor axis length can be determined to be acceptable if it is equal to or less than an allowable gap value, or unacceptable if it exceeds the allowable gap value.

Upon testing the inspection apparatus 100, the inventors have discovered that the size of the horizontally long figure D is not stable. As a result, the measured minor axis length has greatly differed from the size of the gap 111. Therefore, inspections have been unreliable.

The reasons for the size of the horizontally long figure D being unstable can be considered to be as follows.

A gap 111 forms between the attachment part 108 and the valve seat 109, as shown in FIG. 1A. When area b in FIG. lOA is enlarged, multiple cut-out parts 112 in the casting surface can be seen, as shown in FIG. 10B. When a cut-out part 112 is enlarged, microscopic burrs 113 can be seen, as shown in FIG. 10C.

The formation mechanism of the burrs 113 is as follows. The cylinder head 107 shown in FIG. 10A is cut along a shearing wire 115 in a previous step as shown in FIG. 10D. When priority is given to the percent yield of the material, cut-out parts 112 such as the one shown in FIG. 10C cannot be avoided. It would be difficult in practice to completely remove the microscopic burrs 113 because of the increase in labor.

In FIG. 10C, light is reflected and diffused by the cut-out part 112, creating lit areas and shadowed areas. The burrs 113 also create shadowed areas, and the shadowed areas constitute a dark area resembling the gap 111. As a result, the size of the horizontally long figure is believed to be unstable.

A demand exists for a measurement apparatus that can precisely measure the gap between an attachment part and a valve seat despite the presence of cut-out parts and microscopic burrs.

### DISCLOSURE OF THE INVENTION

According to a first aspect of the present invention, there is provided a gap measurement apparatus for measuring gaps that form between valve seats and attachment parts after the attachment parts are formed in exhaust ports of an engine and the valve seats are press-fitted into the attachment parts, wherein the gap measurement apparatus comprises a cylinder, white light-emitting diodes that are provided to one end of the cylinder and that have an illumination axes orthogonal to the axis of the cylinder, a mirror that is provided to one end of the cylinder and that refracts an optical axis by 90°, a CCD camera provided at the other end of the cylinder, and a color image processor for binarizing color image information acquired by the CCD camera; wherein the color image processor performs binarization by evaluating the color of each pixel with the three elements hue, chroma, and brightness.

The illumination axis is orthogonal to the imaged surface. As a result, there are not likely to be dark areas in the cut-out parts, and the microscopic burrs are also not likely to cause dark areas. Additionally, white light-emitting diodes are used for illumination. These white light-emitting diodes have the advantage of fewer occurrences of dark areas as noise in comparison with red, blue, or green light-emitting diodes.

The material can be substantially identified by evaluating hue, the gap can be differentiated from other portions by evaluating chroma, and the precision of binarization based on shading is increased by evaluating brightness.

As a result of the above, a technique can be provided for accurately measuring gaps even in cases of inspecting the proximity of a valve seat containing cut-out parts or microscopic burrs.

Preferably, there are 256 hues, including intermediate colors added to the ten colors red, orange, yellow, greenish-yellow, green, bluish-green, blue, bluish-purple, purple, and reddish-purple so that red is No. 1 and reddish-purple is No. 256, and the range of Nos. 100 through 200 is used as a hue evaluation range; a chroma evaluation range includes the range of Nos. 10 through 50 so that the plainest brightness is No. 1, and the most colorful brightness is No. 256; a brightness evaluation range includes Nos. 30 and below so that black is No. 1 and white is No. 256; and a color image processor performs a binarization process of assigning the number 0 to colors that fulfill the three conditions of the hue evaluation range, the chroma evaluation range, and the brightness evaluation range, and assigning the number 1 to all other colors.

When the inspected surface is illuminated with the white light-emitting diodes, a blue image is obtained when the surface is iron or aluminum. No. 150 substantially matches blue, and blue is used as a basis to narrow down the image to bluish-green, blue, and bluish-purple, whereby other materials can be eliminated.

The chroma of the gap is a blurry color at No. 50 or lower. In view of this, the range of Nos. 10 through 50 is set as the chroma evaluation range, whereby the gap can be identified.

If the brightness is determined once the chroma is limited to Nos. 10 through 50, the brightness of the gap is No. 30 or lower.

A binarization process is performed so that the number 0 is assigned to colors that fulfill the three conditions of having a hue evaluation range within the Nos. 100 to 200, a chroma evaluation range within the Nos. 10 to 50, and a brightness evaluation range of No. 30 or below; and the number 1 is assigned to all other colors. Gaps in the valve seats press-fitted into a cylinder head can thereby be measured with greater precision.

Preferably, the cylinder, the white light-emitting diodes, the mirror, and the CCD camera are mounted on a robot arm.

Mounting the cylinder, the white light-emitting diodes, the mirror, and the CCD camera on a robot arm eliminates the need to manually insert cylinders and other components into the exhaust ports. As a result, the measurement operation can easily be automated and carried out faster.

According to a second aspect of the present invention, there is provided a gap measurement method for measuring gaps that form between valve seats and attachment parts after the attachment parts are formed in exhaust ports of an engine and the valve seats are press-fitted into the attachment parts, and also for determining whether or not these gaps are allowable; said gap measurement method comprising the steps of photographing the gaps between the valve seats and the attachment parts with a CCD camera while illuminating the gaps with white light-emitting diodes; evaluating the colors of each pixel according to the three elements hue, chroma, and brightness with a color image processor to binarize the obtained color image information; totaling the number of white spot pixels obtained from this binarization; and concluding that the gaps between the valve seats and the attachment parts are allowable when the obtained total number of white spot pixels is equal to or less than a total number of pixels for an acceptance standard.

White light-emitting diodes have the advantage of fewer occurrences of dark areas as noise in comparison with red, blue, or green light-emitting diodes.

The material can be substantially identified by evaluating hue, the gap can be differentiated from other portions by evaluating chroma, and the precision of binarization based on shading is increased by evaluating brightness.

As a result of the above, it is possible to provide a technique for precisely measuring gaps, even when inspecting the proximity of valve seats that include cut-out parts and microscopic burrs.

### BRIEF DESCRIPTION OF THE DRAWINGS

FIG. 1 is a cross-sectional view showing a relationship between a cylinder head and an apparatus for measuring gaps between attachment parts and valve seats according to the present invention;

FIG. 2 is a cross-sectional view showing the gap measurement apparatus of FIG. 1;

FIG. 3 is a side elevational view as seen from arrows 3-3 of FIG. 2;

FIG. 4 is a schematic view illustrating a method for comparatively testing illuminating light;

FIG. 5 is a graph showing a relationship between brightness and the number of mistakenly detected pixels;

FIG. 6 is a flowchart showing a mode of determining a standard for judging the acceptability of a gap;

FIG. 7 is a perspective view showing a production.line using the gap measuring apparatus;

FIG. 8 is a schematic view showing an alteration in which the mirror of FIG. 3 is circular;

FIGS. 9A and 9B are views showing a conventional gap measurement method using a conventional gap measurement apparatus; and

FIGS. 10A through 10D are views illustrating problems with the conventional gap measurement apparatus.

### BEST MODE FOR CARRYING OUT THE INVENTION

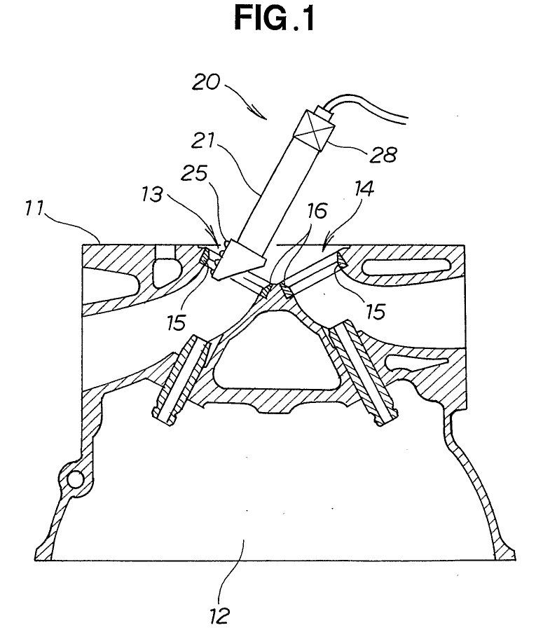

As shown in FIG. 1, a cylinder head 11 of an engine is turned upside-down so that a valve operating chamber 12 is on the bottom, and an apparatus 20 for measuring gaps between attachment parts and valve seats is partially inserted into an air intake port 13 and an exhaust port 14. Measurements are then conducted with the apparatus 20 for measuring gaps between attachment parts and valve seats. The air intake port 13 is provided with an attachment part 15 by cutting the side nearer to the cylinder head 11, and a valve seat 16 is press-fitted into this attachment part. The same applies to the release port 14.

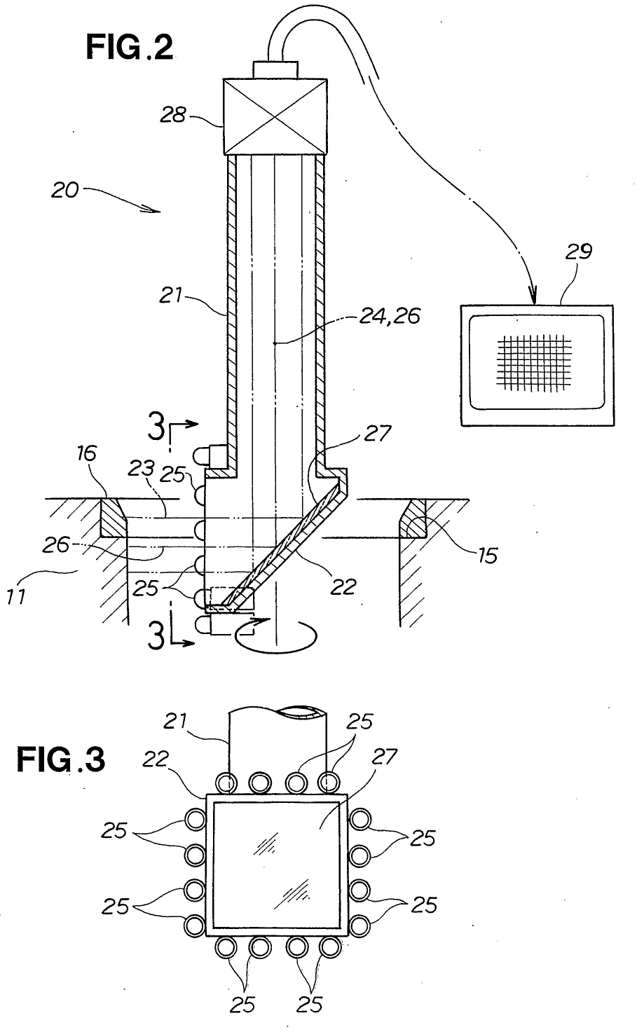

As shown in FIG. 2, the apparatus 20 for measuring gaps between attachment parts and valve seats is composed of a cylinder 21, a mirror accommodation chamber 22 that has a substantially triangular cross-section and is provided to one end (lower end in the Figure) of the cylinder 21, white light-emitting diodes 25 that are provided around the periphery of the mirror accommodation chamber 22 and that are orthogonal to an axis 24 of the cylinder, a mirror 27 that is provided to the mirror accommodation chamber 22 and that refracts an optical axis 26 by 90°, a CCD camera 28 provided at the base (upper end in the Figure) of the cylinder 21, and a color image processor 29 for binarizing color image information acquired by the CCD camera 28.

As shown in FIG. 3, multiple white light-emitting diodes 25 are attached around the periphery of the mirror accommodation chamber 22 so as to emit white light towards the face of the Figure.

The light-emitting diodes, abbreviated as LEDs, are electronic components that emit light that has excellent rectilinear propagation properties, and red, blue, green, and white light-emitting diodes are used in actual practice.

The light-emitting diodes of these four colors were compared in an experiment, and the following is a description of the results.

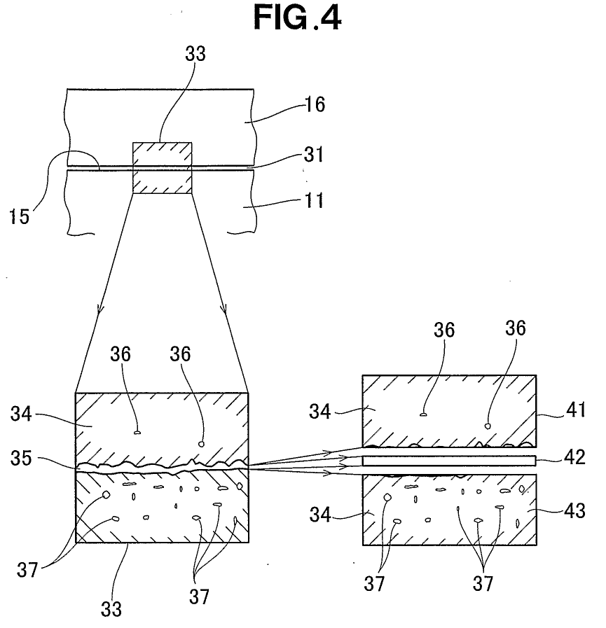

The experiment for comparing emitted light is conducted while light is emitted by red, blue, green, and white light-emitting diodes. A gap 31 is aligned substantially in the middle as shown in FIG. 4, and part of a valve seat 16 and a cylinder head 11 are photographed. An image 33 of a specified size can thereby be obtained. This image 33 has 720,000 pixels.

When the image 33 is enlarged, a white band 35 appears in the middle of a ground-color portion 34 that occupies a large portion of the image; a few white spots 36, 36 are seen above the white band 35 (the range of the seat ring); and innumerable white spots 37 are seen below the white band 35 (the range of the cylinder head). The number of pixels in the white band 35 and in the white spots 36, 36, 37 is tabulated. This tabulated value is referred to as the total number of white spot pixels.

Next, a process is performed to define the white band 35. The gap range, the seat ring range, and the cylinder head range are partitioned to obtain divided images 41, 42, and 43.

The top divided image 41 and the bottom divided image 43 represent regions other than the gap. Therefore, the white spots 36, 36 in the top divided image 41 and the white spots 37, 37 in the bottom divided image 43 are mistakenly detected but are not gaps. In view of this, the number of pixels is tabulated in the white spots 36, 36 in the top divided image 41 and in the white spots 37, 37 in the bottom divided image 43. This tabulated value is referred to as the number of mistakenly detected pixels.

The following table shows the results of finding the total number of white spot pixels and the number of mistakenly detected pixels while using red, blue, green, and white light-emitting diodes, and keeping other conditions constant.

TABLE

| | | | | Number B | |
|---|---|---|---|---|---|
| | | | Total | of | |
| | Light- | Total | number A of | mistakenly | Mistaken |
| | emitting | number of | white spot | detected | detection |
| Experiment | diodes | pixels | pixels | pixels | rate C |
| 1 | red | 72 × 10⁴ | 7.0 × 10⁴ | 5.3 × 10⁴ | 76% |
| 2 | blue | 72 × 10⁴ | 3.2 × 10⁴ | 1.4 × 10⁴ | 44% |
| 3 | green | 72 × 10⁴ | 2.3 × 10⁴ | 0.6 × 10⁴ | 26% |
| 4 | white | 72 × 10⁴ | 1.0 × 10⁴ | 44 | 0.4% |

Red light-emitting diodes were used in Experiment No. 1. The total number of pixels was 720,000, and the total number of white spot pixels therein was 70,000. The number of mistakenly detected pixels was 53,000. The rate of mistaken detection was 76%, as calculated using the formula (5.3/7)×100=76.

Similarly, in Experiment No. 2 (in which red light-emitting diodes were used), the mistaken detection rate was 44%, and in Experiment No. 3 (in which green light-emitting diodes were used), the mistaken detection rate was 26%.

The adverse effects of cut-out parts and microscopic burrs in the casting surface are thought to be more severe with red diodes. Although blue and green diodes had some improvement, the adverse effects of cut-out parts and microscopic burrs are believed to remain.

In Experiment No. 4, a white light-emitting diode was used. The total number of pixels was 720,000, and the total number of white spot pixels was 10,000. The number of mistakenly detected pixels was small at 44. The mistaken detection rate was 0.4%, calculated by (44/10,000)×100=0.44. With white light-emitting diodes, it was confirmed that the effects of cut-out parts and microscopic burrs could be sufficiently eliminated.

Next, white light-emitting diodes were used to obtain a color image, and this color image was examined in terms of the three elements hue, chroma, and brightness.

A valve seat is configured from an iron-based material and is mechanically processed, which forms the surface into a smooth surface resembling a mirror. A cylinder head is configured from an aluminum alloy casting and the exhaust ports are mechanically processed, but the surface has cut-out parts and microscopic burrs.

The valve seat and cylinder head were irradiated with white light-emitting diodes to obtain a color image, whereupon the hue of the image resembled “blue.” If the photographed image was a copper-based material, the hue resembled “red.” The hue resembled “blue” with a combination of an iron-based material and an iron-based material, or a combination of an iron-based material and an aluminum-based material. During measurement, it is preferable to confirm the extent of mechanical processing and the combination of materials.

Intermediate colors are added to the ten colors red, orange, yellow, greenish-yellow, green, bluish-green, blue, bluish-purple, purple, and reddish-purple for a total of 256 hues. Red is No. 1, purple is No. 256, and the range of Nos. 100 through 200 (bluish-green, blue, and bluish-purple) is used as the hue evaluation range with blue in the center.

Next, observing the portion of the gap showed the gap to have a dull, bluish color.

Chroma was tested multiple times, wherein the plainest brightness was No. 1, and the most colorful brightness was No. 256. As a result, a dull bluish color was in the range of Nos. 10 through 50. Beyond No. 50, there is an increased chance of detecting bright spots outside of the gap (valve seat or cylinder head).

In view-of this, the chroma evaluation range was from No. 10 to No. 50.

Brightness was examined as described above, using Nos. 100 through 200 for hue and Nos. 10 through 50 for chroma.

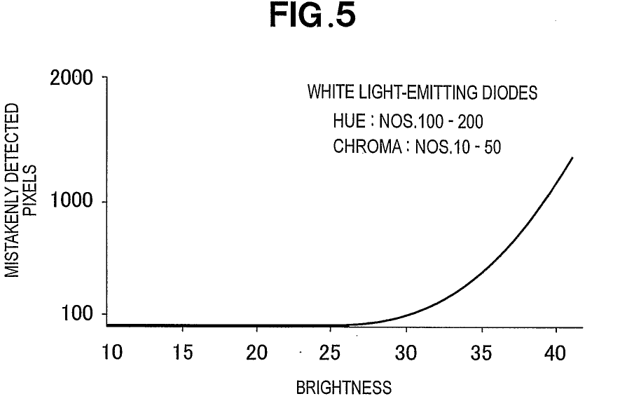

White light-emitting diodes were used and brightness was varied in a color image in which the hue range was set to Nos. 100 through 200 and the chroma range was set to Nos. 10 through 50, to find the conditions under with mistakenly determined pixels appeared. The results are shown in FIG. 5. For brightness, black was No. 1 and white was No. 256.

In FIG. 5, no mistaken detection was observed at a brightness of No. 27 or less. The number of mistakenly detected pixels exceeded 1000 at a brightness of No. 40 or greater. In Experiment 4 shown in the table above, the total number of white pixels was 10,000. Therefore, if the allowable mistaken detection rate is 1%, then about 100 detections are allowable according to the calculation 10,000×0.01=100.

The number 100 on the vertical axis in the graph is equivalent to a brightness of No. 30.

In view of this, the brightness evaluation range is No. 30 or less, preferably No. 27 or less, and more preferably No. 25 or less.

Mistaken detection can thereby be eliminated, making the measurements more reliable.

The following is a description of the method for creating a reference for determining whether a measurement is acceptable.

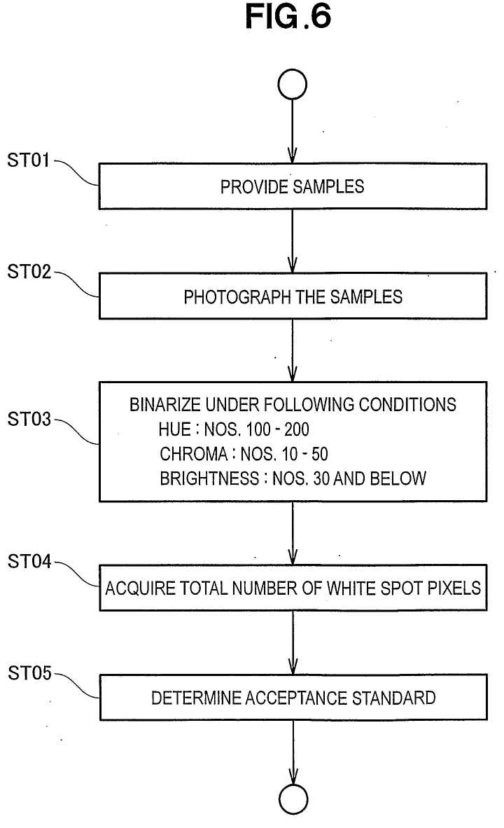

FIG. 6 is a flowchart of creating the acceptability standard according to the present invention.

In step No. (hereinafter abbreviated as ST) 01, samples (valve rings and cylinder heads) are provided in which the gaps are adjusted to 5 μm (FIG. 4), 10 μm, and 20 μm.

In ST02, the samples are photographed to capture color images.

In ST03, the color images are binarized with hues of Nos. 100 through 200, chroma levels of Nos. 10 through 50, and brightness levels of No. 30 or less. Specifically, pixels fulfilling these three conditions are labeled as “white,” and other pixels are labeled as “other colors” (FIG. 4).

In ST04, the total number of white spot pixels is calculated and acquired.

ST05: The total number of white spot pixels for a 10 μm gap is determined by referring to the total number of white spot pixels for a 5 μm gap, the total number of white spot pixels for a 10 μm gap, and the total number of white spot pixels for a 20 μm gap. This determined total number of white spot pixels is used as an acceptability standard, and a [number of pixels] equal to or less than the determined total number of white spot pixels should be concluded acceptable, while a [number of pixels] exceeding the determined total number of white spot pixels should be concluded unacceptable.

The total number of white spot pixels for a 5 μm gap and the total number of white spot pixels for a 20 μm gap are supplementary data for finding the likelihood of the total number of white spot pixels for a 10 μm gap.

The following is a description of an example in which an apparatus for measuring gaps between attachment parts and valve seats is installed in a production line.

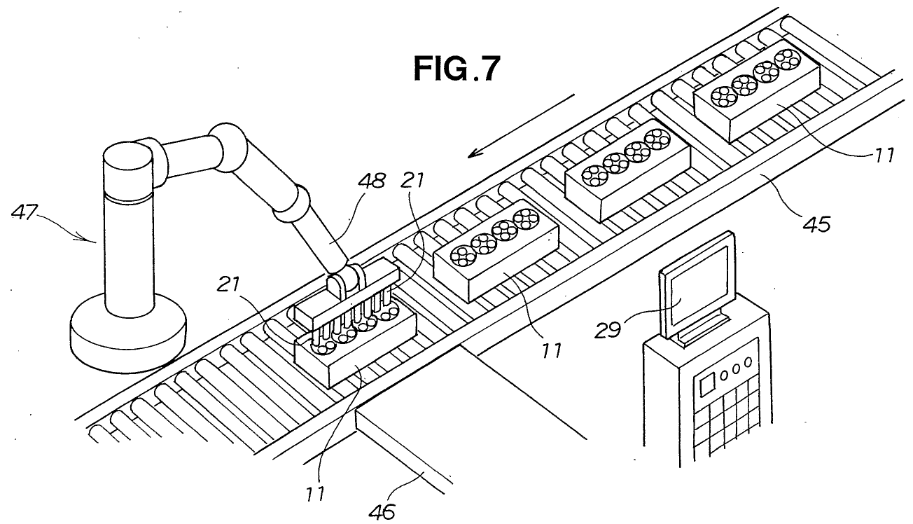

A branch line 46 is set up next to a conveyor line 45, and a robot 47 and the color image processor 29 are provided in proximity to the branch line 46, as shown in FIG. 7. A robot arm 48 of the robot 47 is provided with multiple cylinders 21 or the like.

The distal ends of the cylinders 2 lare inserted into the cylinder heads 11 that move as indicated by the arrow, and the gaps are measured. If the inspector observing the color image processor 29 concludes that that a cylinder is unacceptable, the failed cylinder head 11 is moved to the branch line 46. The production line may be made unmanned by determining acceptability with the color image processor 29.

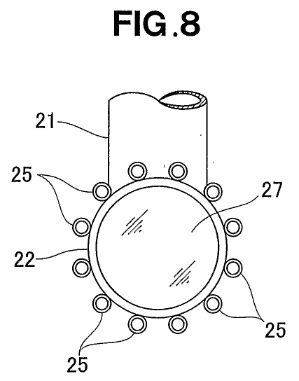

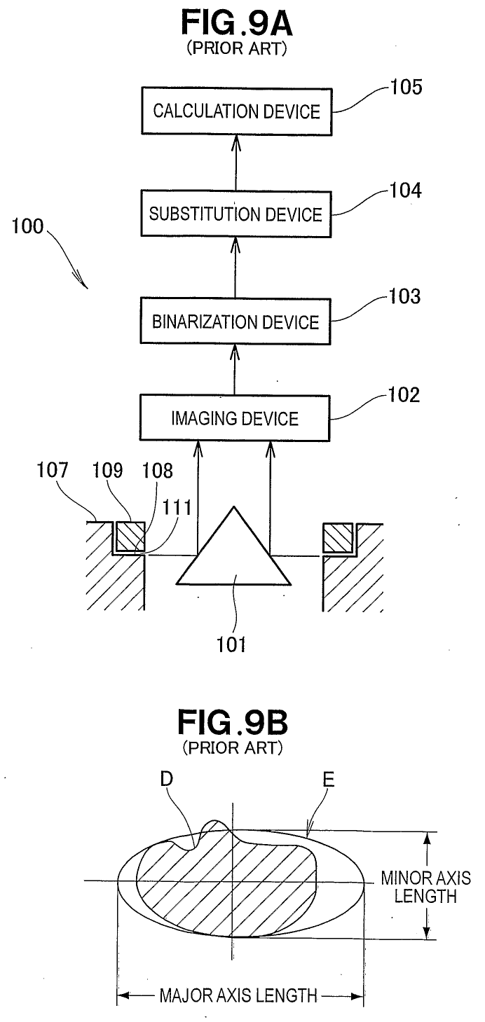

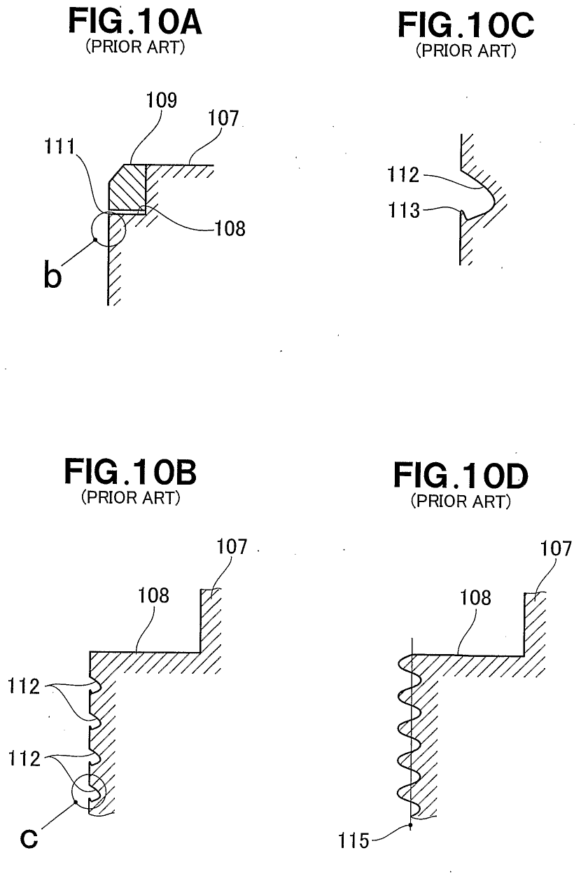

Another embodiment of FIG. 3 is described in FIG. 8. In FIG. 3, the mirror accommodation chamber 22 is shaped as a rectangular prism, but in FIG. 8, the mirror accommodation chamber 22 is shaped as a cylinder. If the chamber is a cylinder, all of the white light-emitting diodes 25 and the like can be disposed at equal distances from center of the mirror 27, and clear images with no irregularities can be obtained.

The evaluation ranges for hue, chroma, and brightness can be determined for the material of the cylinder head, and the material and size of the valve seats.

The present invention is suitable as an apparatus for measuring gaps between valve seats and attachment parts, but can also be used to measure any form of gaps regardless of the type. Therefore, the present invention may be applied to apparatuses for measuring gaps between metal members and other metal members that are not valve seats.

### INDUSTRIAL APPLICABILITY

The present invention is suitable as a measuring apparatus for measuring gaps between valve seats and attachment parts.

1. A gap measurement apparatus for measuring gaps that form between valve seats and attachment parts after the attachment parts are formed in exhaust ports of an engine and the valve seats are press-fitted into the attachment parts, the apparatus comprising:
a cylinder;
white light-emitting diodes provided to one end of the cylinder and having an illumination axes orthogonal to an axis of the cylinder;
a mirror provided to the one end of the cylinder for refracting an optical axis by 90°;
a CCD camera provided at an opposite end of the cylinder; and
a color image processor for binarizing color image information acquired by the CCD camera,
wherein the color image processor performs binarization by evaluating the color of each pixel with the three elements hue, chroma and brightness.

2. The gap measurement apparatus of claim 1, wherein there are 256 hues, including intermediate colors added to the ten colors red, orange, yellow, greenish-yellow, green, bluish-green, blue, bluish-purple, purple, and reddish-purple so that red is No. 1, reddish-purple is No. 256, and the range of Nos. 100 through 200 is used as a hue evaluation range,
a chroma evaluation range includes the range of Nos. 10 through 50 so that the plainest brightness is No. 1, and the most colorful brightness is No. 256,
a brightness evaluation range includes Nos. 30 and below so that black is No. 1 and white is No. 256, and
a color image processor performs a binarization process of assigning the number 0 to the color that fulfills the three conditions of the hue evaluation range, the chroma evaluation range and the brightness evaluation range, and assigning the number 1 to all other colors.

3. The gap measurement apparatus of claim 1, wherein the cylinder, the white light-emitting diodes, the mirror, and the CCD camera are mounted on a robot arm.

4. A gap measurement method for measuring gaps that form between valve seats and attachment parts after the attachment parts are formed in exhaust ports of an engine and the valve seats are press-fitted into the attachment parts, and also for determining whether or not these gaps are allowable, the method comprising the steps of:
photographing the gaps between the valve seats and the attachment parts with a CCD camera while illuminating the gaps with white light-emitting diodes;
evaluating colors of each pixel according to the three elements hue, chroma, and brightness with a color image processor to binarize the obtained color image information;
totaling the number of white spot pixels obtained from this binarization; and
concluding that the gaps between the valve seats and the attachment parts are allowable when the obtained total number of white spot pixels is equal to or less than a total number of pixels for an acceptance standard.

5. The gap measurement method of claim 4, wherein there are 256 hues, including intermediate colors added to the ten colors red, orange, yellow, greenish-yellow, green, bluish-green, blue, bluish-purple, purple, and reddish-purple so that red is No. 1, reddish-purple is No. 256, and the range of Nos. 100 through 200 is used as a hue evaluation range,
a chroma evaluation range includes the range of Nos. 10 through 50 so that the plainest brightness is No. 1, and the most colorful brightness is No. 256,
a brightness evaluation range includes Nos. 30 and below so that black is No. 1 and white is No. 256, and
a color image processor performs a binarization process of assigning the number 0 to the color that fulfills the three conditions of the hue evaluation range, the chroma evaluation range, and the brightness evaluation range, and assigning the number 1 to all other colors.
